(19) United States
(12) Patent Application Publication
(10) Pub. No.: US 2010/0115403 A1
(43) Pub. Date: May 6, 2010

(54) TRANSFORMING MATH TEXT OBJECTS USING BUILD DOWN AND BUILD UP

(75) Inventor: Murray Sargent, III, Medina, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/266,540

(22) Filed: Nov. 6, 2008

(51) Int. Cl. G06F 17/28

(52) U.S. Cl. 715/267

(57) ABSTRACT

Architecture that transforms a built-up mathematical object into a modified linear format object using a customized build down. To transform objects, appropriate changes can be introduced in association with (e.g., prior to or as part of) the build down process to obtain linear format representations for the modified math objects. For example, prior to build-down, linear format operators can be inserted. As part of the build-down, linear format operators can be deleted or changed, and object arguments can be deleted. The modified linear format math object is then built back up into a modified built-up object.

### BACKGROUND

Getting computers to understand human languages is beneficial in increasing the utility of computers. Natural-language translation, speech recognition and generation, and programming are typical ways in which such machine comprehension plays a role. The better the comprehension, the more useful the computer, and hence, there has been considerable current effort devoted to these areas since the early 1960's.

Ironically, one truly international human language that tends to be neglected in this connection is mathematics. With a few conventions, Unicode can encode many mathematical expressions in a readable “nearly” plain text (technically, this format is a lightly marked up format; hence, the use of “nearly”). The format is linear, but it can be displayed in built-up presentation form.

To distinguish the two kinds of formats, the nearly plain-text format is referred to as the linear format and the built-up presentation format is referred to as the built-up format. The linear format is useful for inputting mathematical expressions, displaying mathematics by text engines that cannot display a built-up format, and computer programs, for example. This linear format can be used with heuristics based on the Unicode math properties to recognize mathematical expressions without the aid of explicit math-on/off commands. The recognition is facilitated by Unicode's strong support for mathematical symbols.

Most mathematical expressions can be represented unambiguously in the linear format, from which these expressions can be exported to other programs, and the linear format is more compact and easy to read. However, the linear format does not attempt to include all typographical embellishments. Moreover, embedded in a plain-text environment the linear format lacks most rich-text properties and some mathematical typographical properties.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture transforms a built-up mathematical object into a modified built-up object using a customized build down followed by a build up. To transform objects, appropriate changes can be introduced in association with (e.g., prior to or as part of) the build down process to obtain linear format representations for the modified math objects. For example, prior to build-down, linear format operators can be inserted. As part of the build-down, linear format operators can be deleted or changed, and object arguments can be deleted. The modified linear format math object is then built back up into a modified built-up object.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented math object processing system.

FIG. 2 illustrates an alternative embodiment of math object processing system.

FIG. 3 illustrates possible implementations of the disclosed math object transformation architecture.

FIG. 4 illustrates a flow diagram for one example of math object transformation related to column addition in a matrix.

FIG. 5 illustrates a method of processing math objects in accordance with the disclosed architecture.

FIG. 6 illustrates a method of transforming a math object by insertion during the build-down process.

FIG. 7 illustrates a method of transforming a math object by deletion during the build-down process.

FIG. 8 illustrates a method of transforming a math object by changing an operator during the build-down process.

FIG. 9 illustrates a method of transforming a math object by argument deletion during the build-down process.

FIG. 10 illustrates a block diagram of a computing system operable to execute transformation of math objects in accordance with the disclosed architecture.

### DETAILED DESCRIPTION

The disclosed architecture facilitates the conversion of a math text object in a first format to a different object in that format by implementing a customized build down to a linear format of a different object followed by build up to the first format of a modified object. The architecture can be embedded in a rich-text environment where the linear format can faithfully represent rich mathematical text to handle some embellishments in the higher-level layer that handles rich text properties such as text and background colors, font size, footnotes, comments, hyperlinks, etc.

Following is an example that converts a stacked fraction (numerator over denominator separated by a line) in a built-up format to a linear fraction (numerator left of a forward slash symbol followed by the denominator on the right side of the slash). The conversion is performed by building down the stacked fraction into the linear format, which inserts parentheses, if needed, to preserve the meaning, followed by changing the linear format fraction operator from U+002F (the Unicode character solidus) to the linear fraction operator U+2215 (the Unicode character Division Slash), and then building up to the second format.

The following equation demonstrates a stacked fraction on the left and its equivalent in linear format on the right.

$$\frac{a + b}{c + d} = ( a + b ) / ( c + d )$$

Note that without the use of the parentheses in the linear format on the right side, the equation is interpreted as the addition of three separate quantities a, b/c, and d, which has a different meaning from

$$\frac{a + b}{c + d} .$$

Some word procesors do not insert the parentheses when changing from stacked form to linear form thereby incorrectly altering the math object. The disclosed architecture transforms a math object by a customized build down to the linear format of a modified object, and then builds back up to obtain the desired modified object.

In this description the usual two-dimensional way mathematical objects are displayed is referred to as “built-up” format and in “built-down” (or “linear”) format. The linear format is particularly convenient for entering mathematical text and for storing the math text in plain-text files.

Conventionally, many object transformations can be performed simply by changing character formatting attributes of a math object, such as changing the accent character of an accent object as in \dot{x}→\ddot{x}. In contrast, the transformations considered herein involve changes to the basic underlying structure of the math object.

In the built-up format, mathematical objects such as fraction, subscript, and matrix can be represented by a start delimiter, a first argument, an argument separator (if the object has more than one argument), a second argument, etc., with the final argument terminated by an end delimiter. These delimiters are structure characters. For example, the fraction a over b is represented in built-up format by {_{frac} a|b} where the “{_{frac}” is a start delimiter, the vertical slash “|” is the argument separator, and the closed curly bracket “}” is the end delimiter.

Similarly, the subscript math object ab is represented by {_{sub} a|b}. Here, the start delimiter can be the same character for all math objects (e.g., the Unicode character U+FDD0), while other programs can use different characters. The kind information of the math object can be specified by a rich-text object-name property associated with the start delimiter. Thus, in plain text, the built-up forms of the fraction and subscript are identical if the fraction arguments are the same as the subscript counterparts. In the following example, a plain-text search for {_{frac} a|b} matches both {_{sub} a|b} and {_{frac} a|b}.

In the usual build-down (linearization) process, a built-up mathematical expression is converted into a linear-format representation that can be built up to regain the original expression. This is called “round tripping” the built-up mathematical expressions through the linear format.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

The disclosed architecture provides a powerful approach to transform built-up mathematical objects in various ways, such as inserting and deleting matrix rows and columns, for example. Generally, the approach transforms a modified math object in a built-up format to the linear format representation via a customized build down process followed by build-up using the modified object.

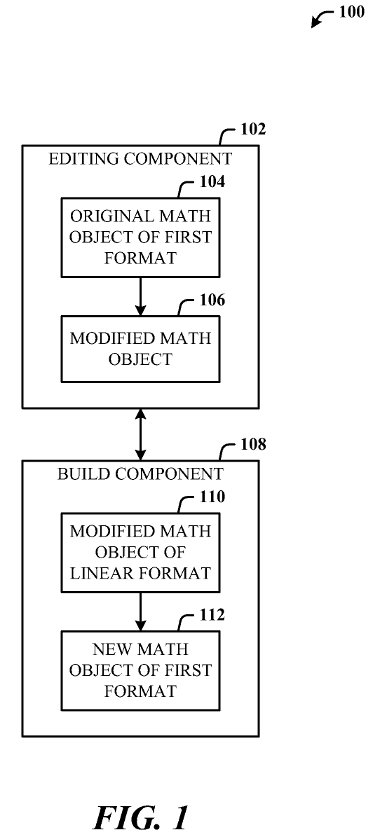

FIG. 1 illustrates a computer-implemented math object processing system 100. The system 100 includes an editing component 102 for editing an original math object 104 of a first format into a modified math object 106. The system 100 also includes a build component 108 for transforming the modified math object 106 into a modified object of a linear format 110 as part of a build-down process and transforming the modified object of the linear format 110 from the linear format into a new math object 112 of the first format as part of a build-up process.

As is described in greater detail herein, the original math object 104 can be edited into the modified math object 106 by the editing component 102 during the build-down process. The modified math object 106 includes linear-format operators inserted during the build-down process. The original math object 104 can be edited into the modified math object 106 prior to the build-down process. The modified math object 106 can include linear-format operators inserted prior to the build-down process. The original math object 104 can be edited by deleting an associated linear-format operator, changing an associated linear-format operator, and deleting an argument of the original math object. The first format can be the built-up format such that round-tripping occurs between the built-up format and the linear format.

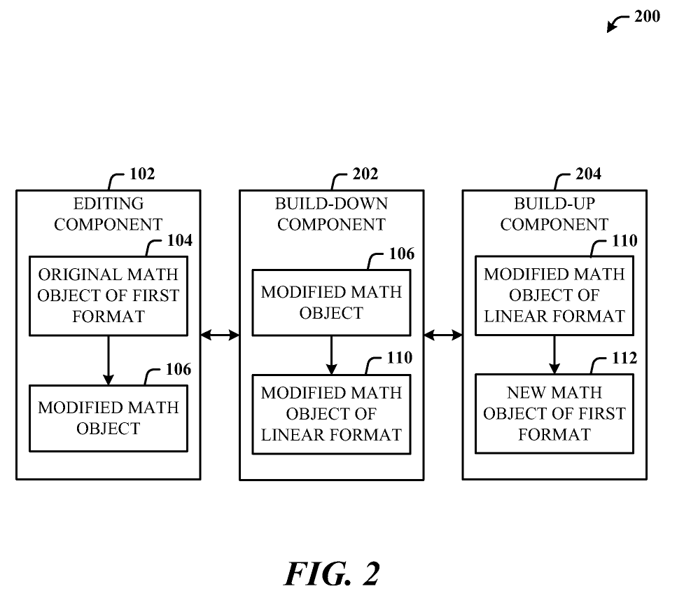

FIG. 2 illustrates an alternative embodiment of math object processing system 200. The system 200 includes the editing component 102 for editing the original math object 104 of a first format into the modified math object 106. A build-down component 202 (or engine) processes the modified math object 106 into the modified math object of the linear format 110, and a build-up component 204 of the system 200 processes the modified math object of the linear format 110 into the new math object of the first format 112.

The build-down component 202 can employ the editing component 102 during the build-down process to delete a linear-format operator. The build-down component 202 can employ the editing component 102 during the build-down process to insert a linear-format operator. The editing component 102 facilitates insertion of a linear-format operator prior to the build-down process. The build-down component 202 can employ the editing component 102 to delete an argument of the original math object 104 of the first format (e.g., built-up).

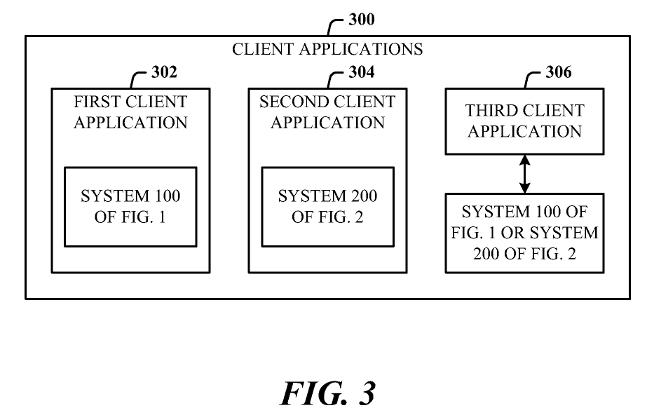

FIG. 3 illustrates possible implementations of the disclosed math object transformation architecture. For example, a client system can comprise client applications 300 such that a first client application 302 includes the system 100 of FIG. 1 for math object transformation, a second client application 304 includes the system 200 of FIG. 2 for math object transformation, and a third client application 306 interacts with an external embodiment of either the system 100 of FIG. 1 or the system 200 of FIG. 2. The client applications 300 can include a word processing application, a spreadsheet application, and/or other applications that employ math object processing. The client applications 300 can include context menus via which a user can interact to facilitate editing prior to or during build-down processing. The menus can allow the user to insert columns before or insert columns after, in a matrix, for example, without the user needing to directly edit the objects.

Following is a more detailed description using examples that illustrate application of the disclosed math object transformation architecture.

To transform math objects, the appropriate changes can be introduced in the build-down process or prior to the build-down process to obtain linear format representations for modified mathematical objects, which are then built up into the desired new mathematical objects. In other words, the modifications can come in two main forms: insert linear-format operators before building down, and/or build down the mathematical objects, deleting or changing the associated linear-format operators or deleting specific object arguments.

In an example of a matrix, the first form can be used for inserting a row or column into the matrix, as well as inserting a separator in the delimiters object. Specifically, to insert a matrix row before/after the current row, an at character ‘@’ separator is inserted at the start/end of the current row. After build-down and build-up, the at character separator transforms into an empty row before/after the current row. For example, inserting a row after the first row results in the following transformation, where the black square ▪ is a matrix Unicode character (e.g., U+25A0) that causes the matrix elements to align in row by column format, and □ is a placeholder that facilitates viewing the change between the original and modified objects.

$$( \begin{matrix}a & b \\ c & d\end{matrix} ) -> ( • ( a \& b @@ c \& d ) ) -> ( \begin{matrix}a & b \\ • & • \\ c & d\end{matrix} )$$

This is summarized in the table below, which gives the linear format for both the original and modified matrices.

| Original | | | |
|---|---|---|---|
| matrix | Linear Format | Modified LF | Modified matrix |
| $( \begin{matrix}a & b \\ c & d\end{matrix} )$ | (▪(a&b@c&d)) | (▪(a&b@@c&d)) | $( \begin{matrix}a & b \\ • & • \\ c & d\end{matrix} )$ |

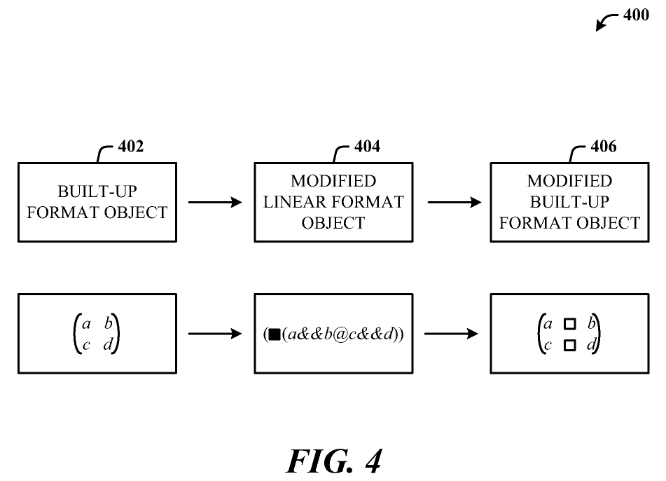

FIG. 4 illustrates a flow diagram 400 for one example of math object transformation related to column addition in a matrix. To insert a matrix column before/after the current column, an ampersand character ‘&’ can be inserted before/after all matrix cells with the same column index as the current argument. The process begins with a built-up format object 402, which is the original matrix shown below in the table. The original matrix is then processed into the linear format and the ampersand character is inserted into the linear format thereby creating a modified linear format object 404. Build-up processes the modified linear format object 404 into a modified built-up format object 406. The ampersand characters ‘&’ transform into an empty column before/after the first current column. For example, inserting a new column after the first column results in the transformation summarized in the following table.

| Original | | | |
|---|---|---|---|
| matrix | Linear Format | Modified LF | Modified matrix |
| $( \begin{matrix}a & b \\ c & d\end{matrix} )$ | (▪(a&b@c&d)) | (▪(a&&b@c&&d)) | $( \begin{matrix}a & • & b \\ c & • & d\end{matrix} )$ |

To insert a separator in a delimiter object (e.g., a parenthesized expression), the separator operator character is inserted at the current position. After build-down and build-up, this character is transformed into a new separator. For example, inserting a separator between the a and b in [symbol] ab [symbol] results in [symbol] a|b [symbol] . This math object has two arguments, a and b; whereas [symbol] ab [symbol] only has the single argument ab.

The simplest transformations using the second kind of change are removing the outermost object. For example, removing the parentheses in the delimiters object (a+b) results in a+b alone. This may seem trivial, but it is easier than selecting the object a+b, copying the object to the clipboard, deleting the object itself, and then pasting the a+b. The approach automatically results in the correct attributes for the resulting expression, including the nesting level, object type, and argument index. Another such transformation is removing an accent, as in the example \hat{z}→z, or removing the horizontal bar in a fraction as in

$$\frac{a}{b} -> \begin{matrix}a \\ b\end{matrix} .$$

A more involved transformation is removing one or more arguments, such as in the transformation e^{a+b}→e, in which the superscript argument is removed from a superscript object. Similarly, a whole row or column of a matrix can be removed, as summarized in the following table.

| Original | | | Modified |
|---|---|---|---|
| matrix | Linear Format | Modified LF | matrix |
| $( \begin{matrix}a & x & b \\ c & y & d\end{matrix} )$ | (▪(a&x&b@c&y&d)) | (▪(a&b@c&d)) | $( \begin{matrix}a & b \\ c & d\end{matrix} )$ |

A similarly useful transformation is converting a stacked fraction to a linear fraction as in the following expression.

$$\frac{a + \frac{b}{c}}{u + \frac{x}{y}} -> ( a + \frac{b}{c} ) / ( u + \frac{x}{y} )$$

In the following example, parentheses need to be inserted, since without the parenthesis incorrect transformation will occur.

$$\frac{a + \frac{b}{c}}{u + \frac{x}{y}} -> a + \frac{b}{c} / u + \frac{x}{{y}^{′}}$$

This is even though internally the linear fraction still has the original numerator and denominator. The build-down process automatically inserts the parentheses, since the linear format for this case has parentheses, and the change is made to replace the stacked-fraction operator U+002F by the linear fraction operator U+2215. Build-up does not discard the parentheses for the linear fraction operator U+2215, but build-up does discard the parentheses for the stacked-fraction operator U+002F.

Other transformations that can be performed with build-down followed by build-up are converting a left subscript/superscript object into an ordinary subscript/superscript object as in ₀¹F→F₀¹, converting a subscript object raised to a power into a subscript/superscript object as in a₀̂2→a₀², and converting a single argument into an equation array as in the lower limit of the summation object, as summarized in the following table.

| Original | | | |
|---|---|---|---|
| sum | Linear Format | Modified LF | Modified sum |
| ${\sum }_{n = 0}^{∞} {a}_{n}$ | 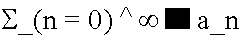 | 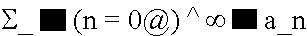 | ${\sum }_{n = 0}^{∞} {a}_{n}$ |

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

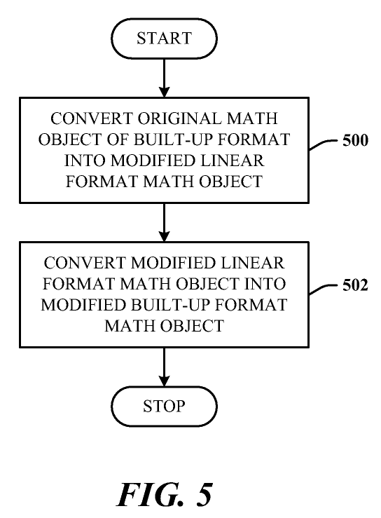

FIG. 5 illustrates a method of processing math objects in accordance with the disclosed architecture. At 500, an original math object of a built-up format is converted into a modified linear format math object. At 502, the modified linear format math object is converted into a built-up modified format math object.

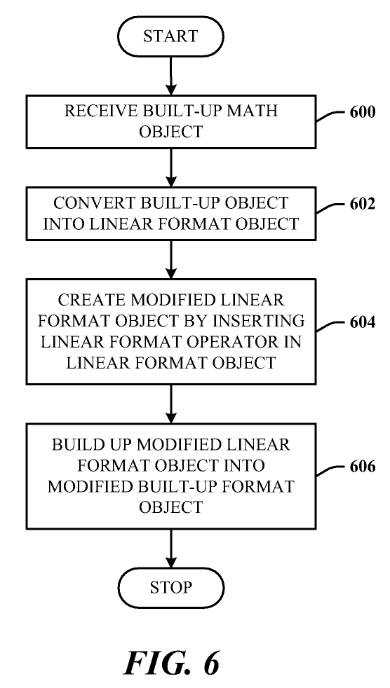

FIG. 6 illustrates a method of transforming a math object by insertion during the build-down process. At 600, a built-up math object is received for processing. At 602, the built-up object is converted in a linear format object. At 604, a modified linear format object is created by inserting a linear format operator in the linear format object. At 606, the modified linear format object is built-up into a built-up modified format object.

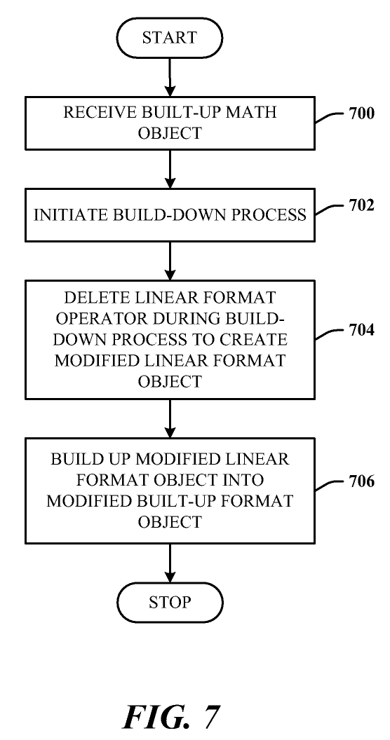

FIG. 7 illustrates a method of transforming a math object by deletion during the build-down process. At 700, a built-up math object is received for processing. At 702, the build-down process is initiated. At 704, a modified linear format object is created by deleting a linear format operator in the linear format object during the build-down process. At 706, the modified linear format object is built-up into a modified built-up format object.

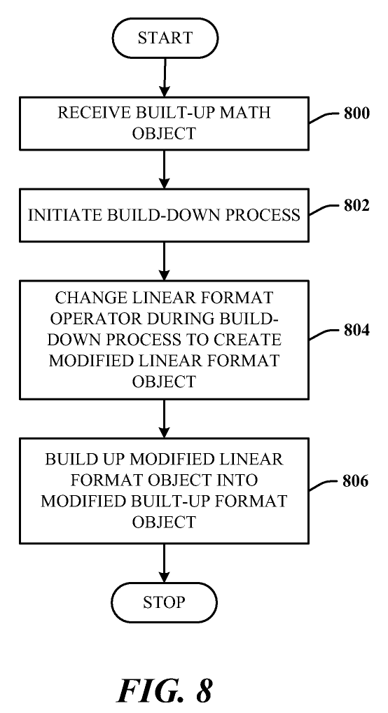

FIG. 8 illustrates a method of transforming a math object by changing an operator during the build-down process. At 800, a built-up math object is received for processing. At 802, the build-down process is initiated. At 804, a modified linear format object is created by changing a linear format operator in the linear format object during the build-down process. At 806, the modified linear format object is built-up into a modified built-up format object.

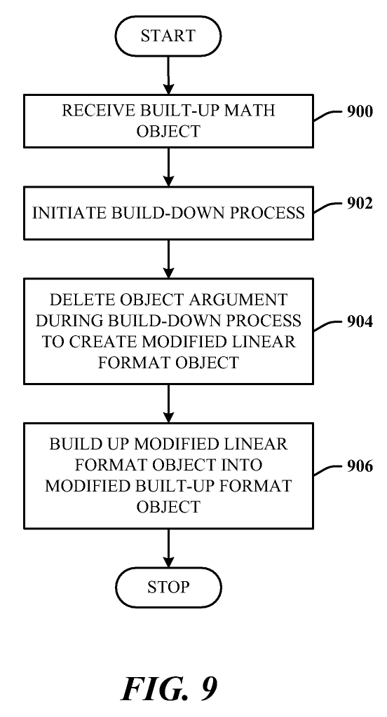

FIG. 9 illustrates a method of transforming a math object by argument deletion during the build-down process. At 900, a built-up math object is received for processing. At 902, the build-down process is initiated. At 904, a modified linear format object is created by deleting an object argument in the linear format object during the build-down process. At 906, the modified linear format object is built-up into a modified built-up format object.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

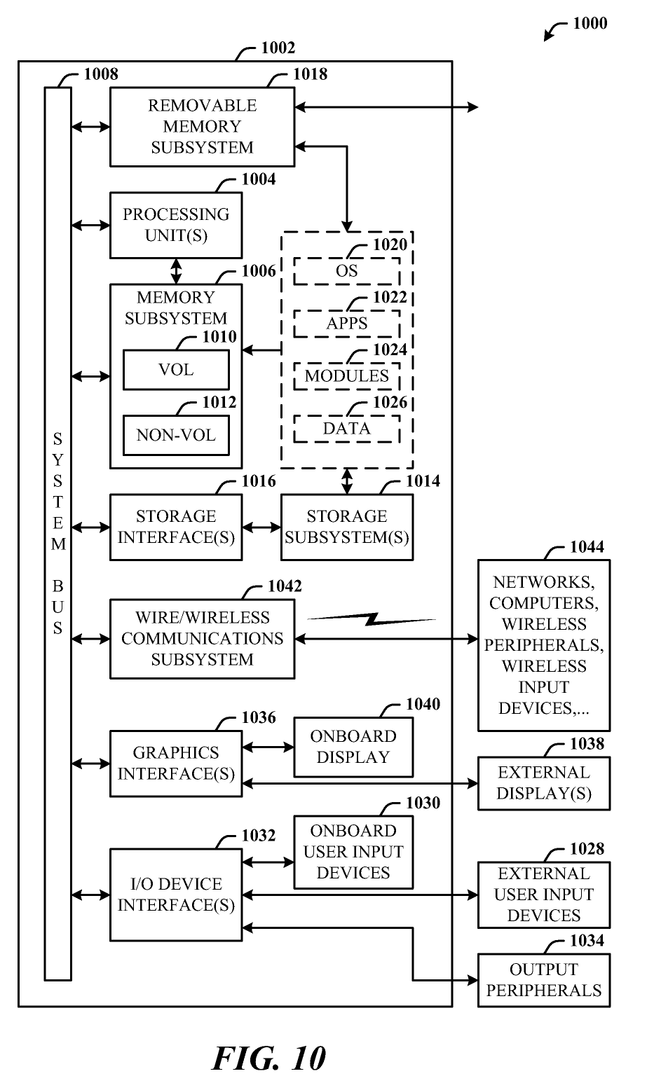

Referring now to FIG. 10, there is illustrated a block diagram of a computing system 1000 operable to execute transformation of math objects in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014, including an operating system 1020, one or more application programs 1022, other program modules 1024, and program data 1026. The one or more application programs 1022, other program modules 1024, and program data 1026 can include the system 100 of FIG. 1, the system 200 of FIG. 2, the client applications 300 of FIG. 3, the flow diagram 400 of FIG. 4, and the methods described relative to FIGS. 5-9. Generally, programs include routines, methods, data structures, other software components, etc., that perform particular tasks or implement particular abstract data types.

All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP) using logical connections via a wire/wireless communications subsystem 1042 to one or more networks and/or other computers. The other computers can include workstations, servers, routers, personal computers, microprocessor-based entertainment appliance, a peer device or other common network node, and typically include many or all of the elements described relative to the computer 1002. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wire/wireless communication subsystem 1042 (e.g., a network interface adapter, onboard transceiver subsystem, etc.) to communicate with wire/wireless networks, wire/wireless printers, wire/wireless input devices 1044, and so on. The computer 1002 can include a modem or has other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented math object processing system, comprising:
an editing component for editing an original math object of a first format into a modified math object; and
a build component for transforming the modified math object into a linear format as part of a build-down process and transforming the modified object from the linear format into a new math object of the first format as part of a build-up process.

2. The system of claim 1, wherein the original math object is edited into the modified math object by the editing component during the build-down process.

3. The system of claim 2, wherein the modified math object includes linear-format operators inserted during the build-down process.

4. The system of claim 1, wherein the original math object is edited into the modified math object prior to the build-down process.

5. The system of claim 4, wherein the modified math object includes linear-format operators inserted prior to the build-down process.

6. The system of claim 1, wherein the original math object is edited by deleting an associated linear-format operator.

7. The system of claim 1, wherein the original math object is edited by changing an associated linear-format operator.

8. The system of claim 1, wherein the original math object is edited by deleting an argument of the original math object.

9. A computer-implemented math object processing system, comprising:
an editing component for editing an original math object of a first format into a modified math object;
a build-down component for transforming the modified math object into a linear format as part of a build-down process; and
a build-up component for transforming the modified object from the linear format into the first format as part of a build-up process.

10. The system of claim 9, wherein the build-down component employs the editing component during the build-down process to delete a linear-format operator.

11. The system of claim 9, wherein the build-down component employs the editing component during the build-down process to insert a linear-format operator.

12. The system of claim 9, wherein the editing component facilitates insertion of a linear-format operator prior to the build-down process.

13. The system of claim 9, wherein the build-down component employs the editing component to delete an argument of the original math object.

14. The system of claim 9, wherein the editing component, build-down component and build-up component operate in association with a word processing application.

15. A computer-implemented method of processing math objects, comprising:
converting an original math object of a built-up format into a modified linear format math object; and
converting the modified linear format math object into a modified built-up format math object.

16. The method of claim 15, further comprising inserting a linear format operator before converting of the original math object of the built-up format into the modified linear format math object.

17. The method of claim 15, further comprising inserting a linear format operator as part of converting of the original math object of the built-up format into the modified linear format math object.

18. The method of claim 15, further comprising deleting a linear format operator as part of converting of the original math object of the built-up format into the modified linear format math object.

19. The method of claim 15, further comprising changing a linear format operator as part of converting of the original math object of the built-up format into the modified linear format math object.

20. The method of claim 15, further comprising deleting an object argument as part of converting of the original math object of the built-up format into the modified linear format math object.
